(19) United States
(12) Patent Application Publication
(10) Pub. No.: US 2017/0229850 A1
(43) Pub. Date: Aug. 10, 2017

(54) ELECTRICAL WIRE COVER

(71) Applicant: Sumitomo Wiring Systems, Ltd., Yokkaichi (JP)

(72) Inventor: Kohei TAKAGI, Yokkaichi (JP)

(21) Appl. No.: 15/427,115

(22) Filed: Feb. 8, 2017

(30) Foreign Application Priority Data
Feb. 8, 2016 (JP) 2016021747

(51) Int. Cl. H02G 3/04

(52) U.S. Cl. CPC H02G 3/0462; H02G 3/0418

(57) ABSTRACT

An electrical wire cover that aims to ease assembly by addressing an electrical wire getting caught between two half covers. The electrical wire cover is a member that has a tube shape when a first half cover that has a half tube shape and a second half cover that has a half tube shape are assembled, and is configured to house an electrical wire. The first half cover has a first inner matching surface, and the second half cover has a second inner matching surface that abuts against the first inner matching surface when the second half cover is attached to the first half cover. The first half cover has an electrical wire restricting protrusion that protrudes toward the second half cover relative to the first inner matching surface.

This application claims the benefit of Japanese Application No. JP2016-021747, filed on Feb. 8, 2016, the contents of which are hereby incorporated by reference in their entirety.

### FIELD

The technology disclosed by the present specification relates to an electrical wire cover.

### BACKGROUND

In order to limit the pathway of electrical wires that are led out from a connector, an electrical wire cover is attached to the connector in some cases (see JP 2013-187060A). This electrical wire cover is provided with a pair of half covers that constitute a tube shape when attached to each other.

### SUMMARY

With the electrical wire cover having the above-described configuration, there are cases in which electrical wires get caught between the two half covers at the time of assembly. Such a situation reduces the ease of assembling the electrical wire cover.

An electrical wire cover disclosed by the present specification is an electrical wire cover having a tube shape when a first half cover that has a half tube shape and a second half cover that has a half tube shape are assembled, and configured to house an electrical wire. The first half cover has a first matching surface, and the second half cover has a second matching surface that abuts against the first matching surface when the second half cover is attached to the first half cover. One half cover out of the first half cover and the second half cover has an electrical wire restricting protrusion. The electrical wire restricting protrusion is a protrusion that protrudes toward the other half cover out of the first half cover and the second half cover, relative to one matching surface, out of the first matching surface and the second matching surface, of the one half cover.

With the above-described configuration, when the first half cover and the second half cover are assembled, even if the electrical wire routed inside juts out to the outside and enters the gap between the first matching surface and the second matching surface, the electrical wire restricting protrusion interferes with the electrical wire, and the electrical wire is pushed back to the inside or pushed to the outside. If the electrical wire is pushed back to the inside, the electrical wire returns to a proper routing position, and the electrical wire is prevented from getting caught. Also, if the electrical wire is pushed to the outside, an operator can be aware that the electrical wire is jutting out. Therefore, the operator can promptly take an appropriate measure such as routing the electrical wire again. As a result, it is possible to prevent the electrical wire from getting caught between the two half covers, and it is possible to avoid a reduction in the ease of assembly.

In the above-described configuration, the electrical wire cover may include: a cover main body; and a holding part that is continuous with the cover main body and holds a protection member that is to be attached to the electrical wire, the holding part may include: a peripheral wall that is configured to surround the electrical wire and the protection member; and a locking wall that extends inward from the peripheral wall, has an electrical wire insertion hole into which the electrical wire is to be inserted, and is locked to the protection member, and the electrical wire restricting protrusion may be located adjacent to the locking wall.

Here, in the part where the locking wall is located, the width of the routing pathway of the electrical wire is narrower than in other parts, and the electrical wire is likely to juts out from the pathway. The electrical wire restricting protrusion is located adjacent to such a part, and therefore it is possible to effectively prevent the electrical wire from getting caught.

In the above-described configuration, the electrical wire restricting protrusion may be located outside a hole edge of the electrical wire insertion hole.

In such a configuration, the electrical wire restricting protrusion is located outside the pathway along which the electrical wire is routed, and therefore it is possible to prevent the routing of the electrical wire from being hindered by the electrical wire restricting protrusion.

With the electrical wire cover disclosed by the present specification, it is possible to avoid a reduction in the ease of assembly caused by electrical wires getting caught between two half covers.

### DRAWINGS

FIG. 1 is a front view of an electrical wire cover according to an embodiment, to which a connector has been attached.

FIG. 2 is a plan view of the electrical wire cover according to the embodiment, to which the connector has been attached.

FIG. 3 is a right side view of the electrical wire cover according to the embodiment, to which the connector has been attached.

FIG. 4 is a front view of the electrical wire cover according to the embodiment.

FIG. 5 is a plan view of the electrical wire cover according to the embodiment.

FIG. 6 is a right side view of the electrical wire cover according to the embodiment.

FIG. 7 is a cross-sectional view along a line A-A shown in FIG. 6.

FIG. 8 is a partially enlarged cross-sectional view showing a situation where an electrical wire is brought back to an inside of the electrical wire cover due to an electrical wire restricting protrusion interfering with the electrical wire.

FIG. 9 is a front view of a first half cover according to the embodiment.

FIG. 10 is a rear view of the first half cover according to the embodiment.

FIG. 11 is a plan view of the first half cover according to the embodiment.

FIG. 12 is a bottom view of the first half cover according to the embodiment.

FIG. 13 is a right side view of the first half cover according to the embodiment.

FIG. 14 is a left side view of the first half cover according to the embodiment.

FIG. 15 is a front view of a second half cover according to the embodiment.

FIG. 16 is a rear view of the second half cover according to the embodiment.

FIG. 17 is a plan view of the second half cover according to the embodiment.

FIG. 18 is a bottom view of the second half cover according to the embodiment.

FIG. 19 is a right side view of the second half cover according to the embodiment.

FIG. 20 is a left side view of the second half cover according to the embodiment.

### DESCRIPTION

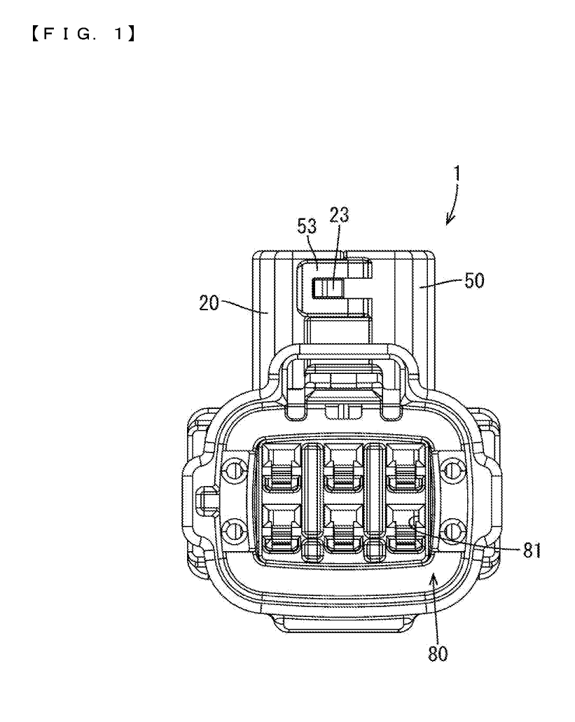

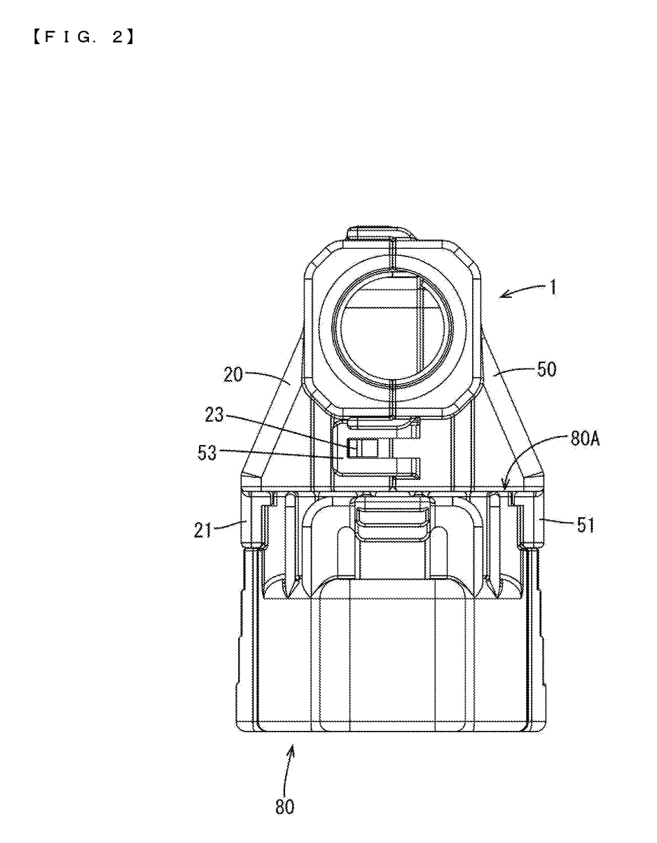

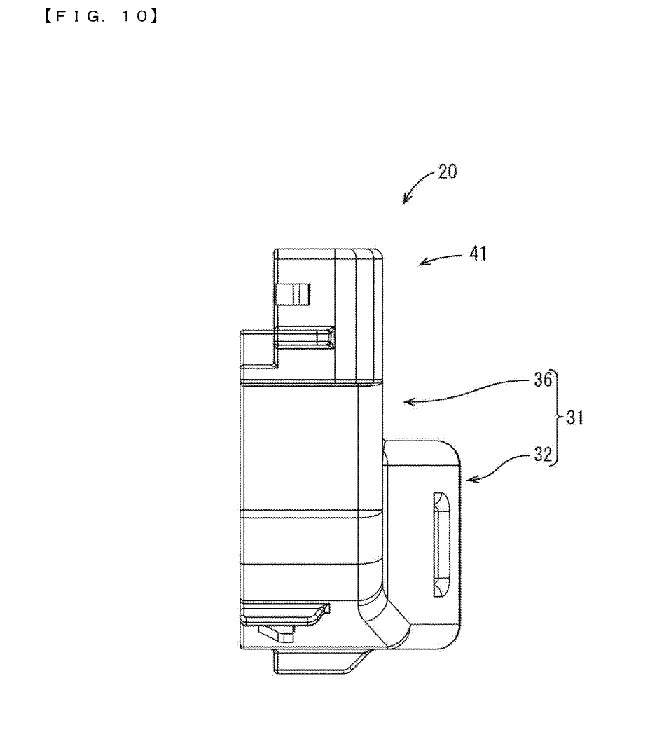

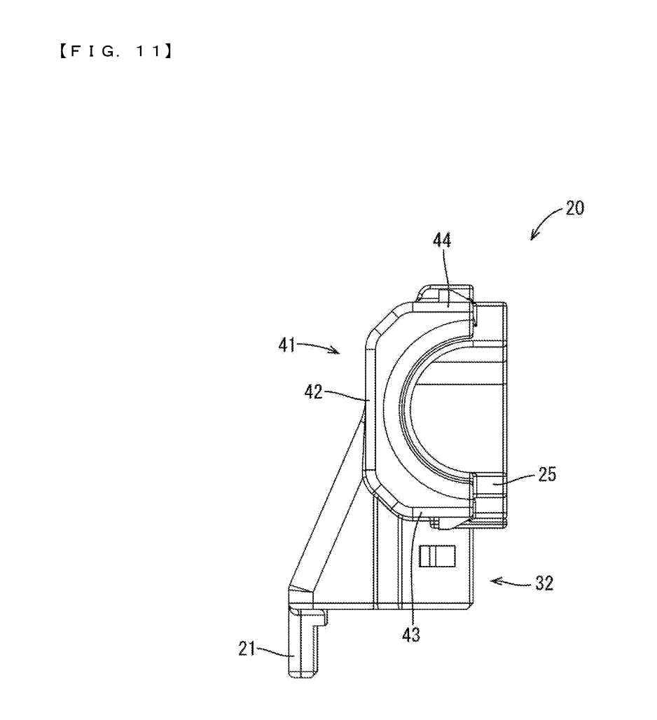

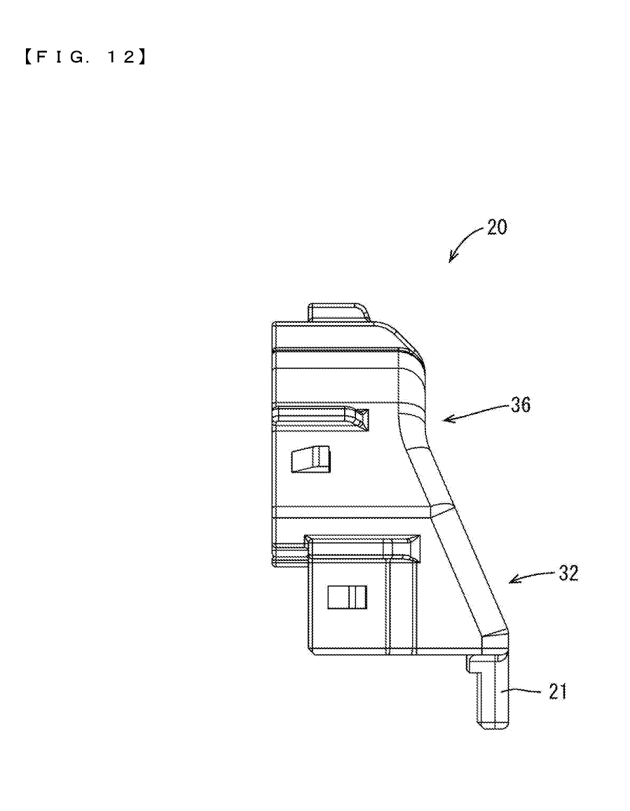

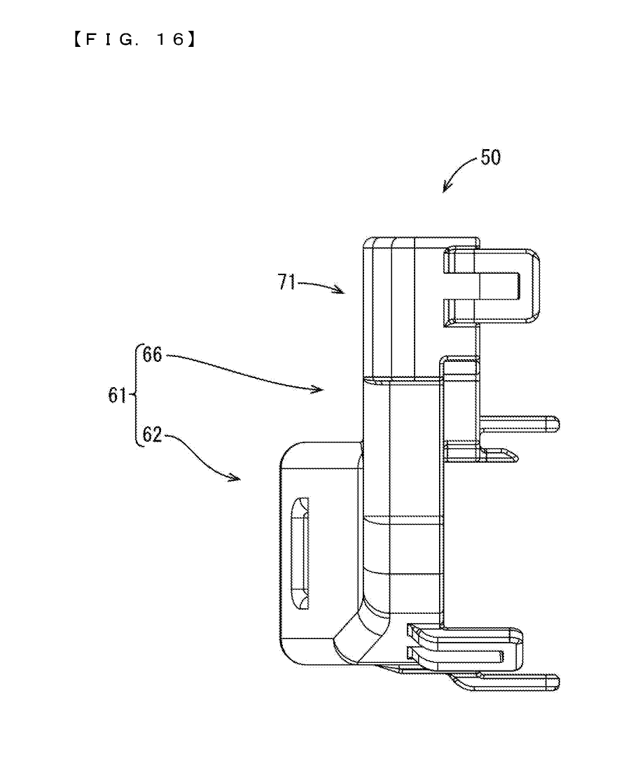

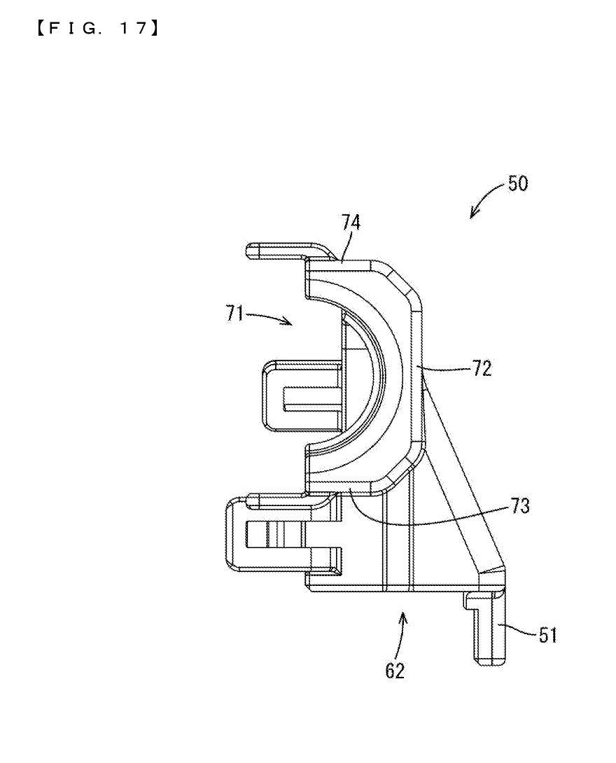

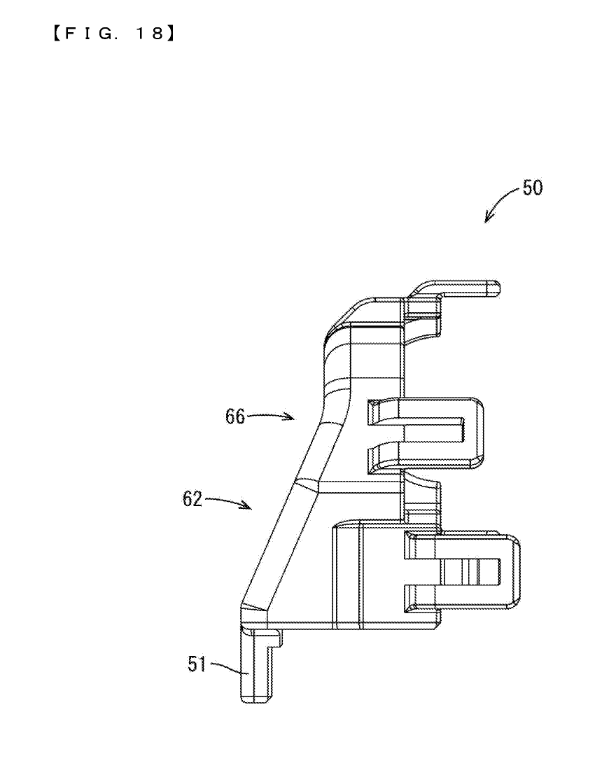

The following describes an embodiment with reference to FIGS. 1 to 20. An electrical wire cover 1 according to the present embodiment is a member that is made of synthetic resin and that is to be attached to a connector housing 80 that holds a plurality of metal terminal parts (not shown) that are attached to a terminal of an electrical wire W.

The connector housing 80 is made of synthetic resin, and, as a whole, has the shape of a rectangular block, as shown in FIGS. 1, 2, and 3. One surface out of a plurality of outer surfaces of the connector housing 80 is an electrical wire draw-out surface 80A from which the electrical wire W is led out. The connector housing 80 includes a plurality of terminal housing parts 81 that are open in the electrical wire draw-out surface 80A, and each terminal housing part 81 houses a metal terminal part therein. The electrical wires W connected to the metal terminal parts extend from the electrical wire draw-out surface 80A to the outside of the connector housing 80, are bundled together, and are inserted into a corrugated tube 90 (corresponding to the protection member). The connector housing 80 has two lock protrusions 82 for engagement with the electrical wire cover 1.

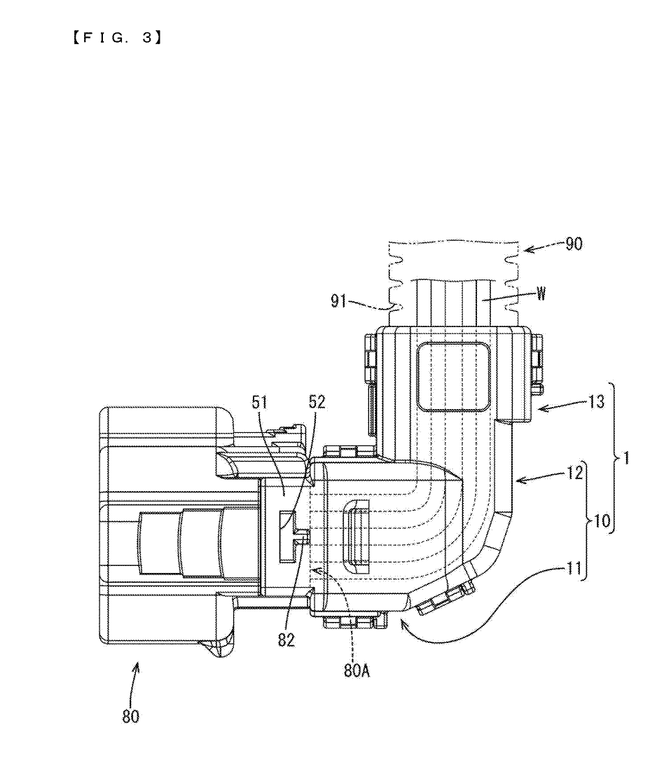

As shown in FIG. 3, the corrugated tube 90 is a cylindrical member that can house the electrical wires W therein, and has a plurality of holding grooves 91 on the outer circumferential surface thereof. Each holding groove 91 is a ring-shaped groove that extends along the circumference direction of the corrugated tube 90, and is recessed inward relative to the outer circumferential surface of the corrugated tube 90.

### Overall Configuration of Electrical Wire Cover 1

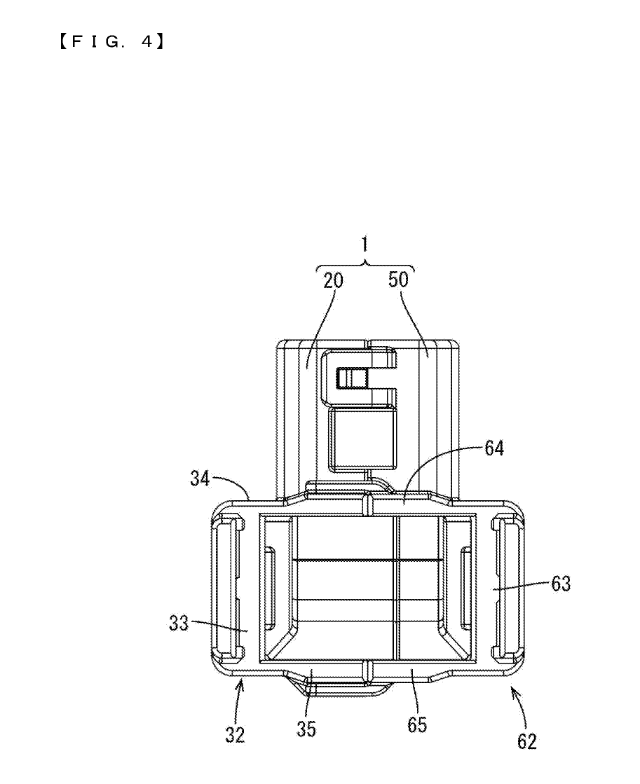

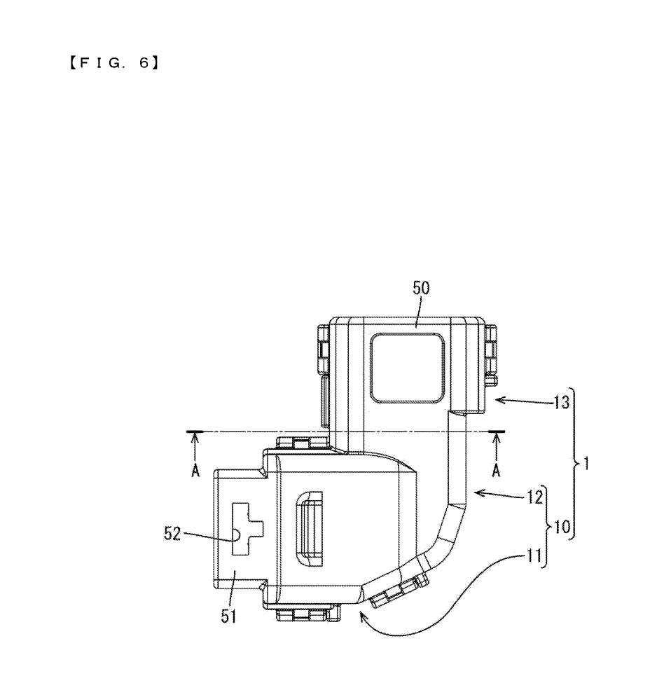

The electrical wire cover 1 is a member that is attached to the connector housing 80 so as to cover the electrical wire draw-out surface 80A, and, as a whole, has the shape of an L-like tube with both ends open, as shown in FIGS. 4, 5, and 6. As shown in FIG. 6, this electrical wire cover 1 includes a cover main body 10 and a holding tube part 13 (corresponding to the holding part) that is continuous with the cover main body 10 and holds the corrugated tube 90.

As shown in FIG. 6, the cover main body 10 includes an orthogonal tube part 11 and a parallel tube part 12. As shown in FIG. 3, the orthogonal tube part 11 is a tube-shaped part that extends in a direction that is orthogonal to the electrical wire draw-out surface 80A when the electrical wire cover 1 is attached to the connector housing 80. The parallel tube part 12 is a tube-shaped part that is continuous with the orthogonal tube part 11 and extends in a direction that is parallel to the electrical wire draw-out surface 80A (in a direction that is orthogonal to the orthogonal tube part 11).

The holding tube part 13 is a tube-shaped part that is continuous with the parallel tube part 12 and extends in a direction along the axis of the parallel tube part 12.

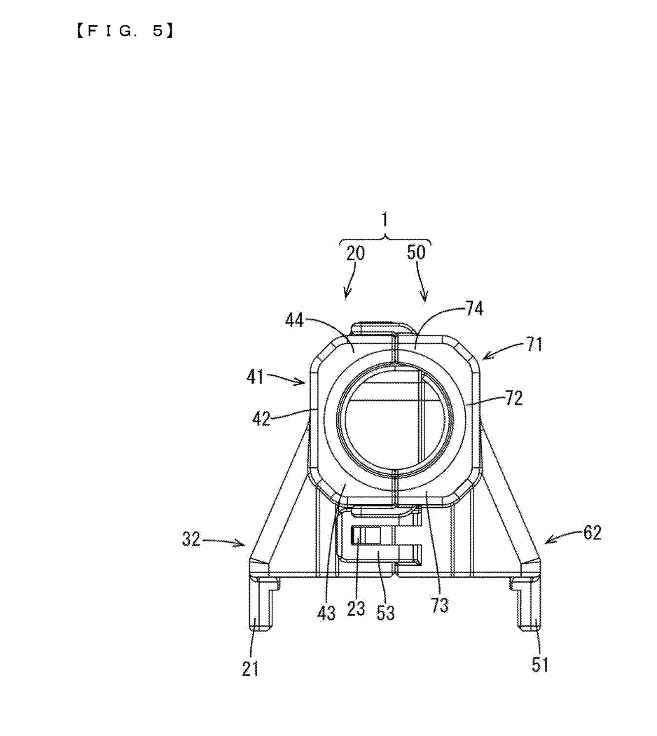

As shown in FIGS. 4 and 5, a first half cover 20 that has a half tube shape and a second half cover 50 that also has a half tube shape are assembled so as to face each other, and consequently the electrical wire cover 1 has a tube shape.

### First Half Cover 20

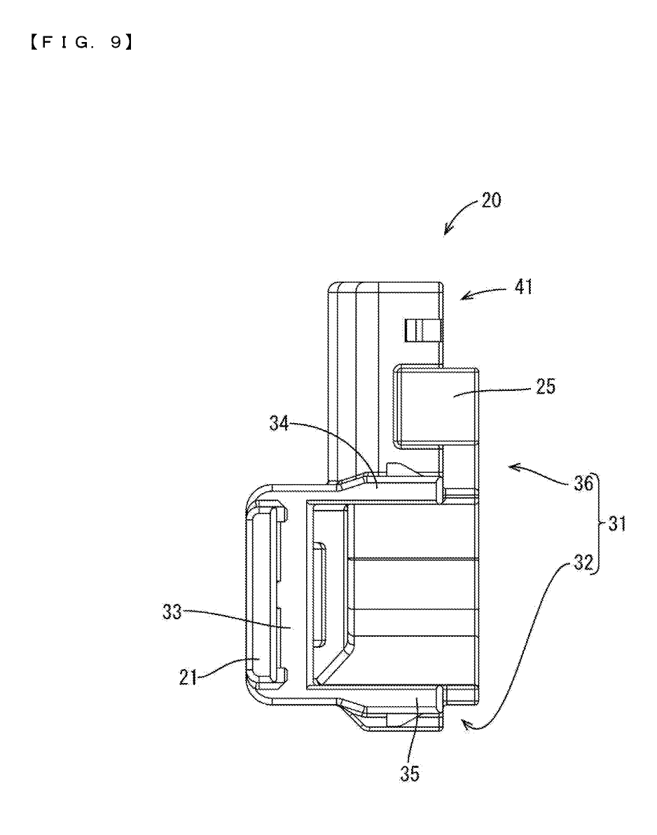

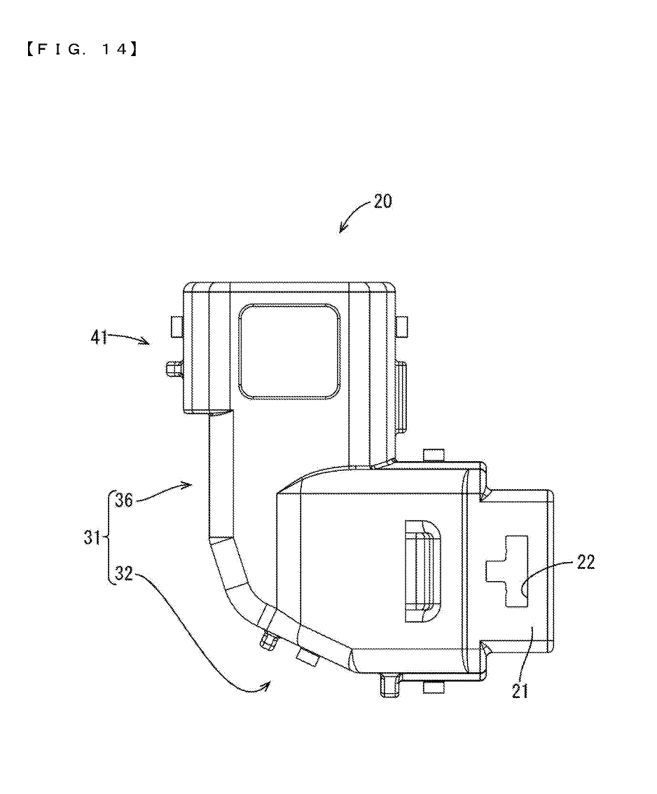

As shown in FIGS. 9 to 14, the first half cover 20, as a whole, has the shape of an L-like tube split in half, and, as shown in FIG. 14, includes a first cover main body 31, a first holding half-tube part 41, and a lock wall part 21.

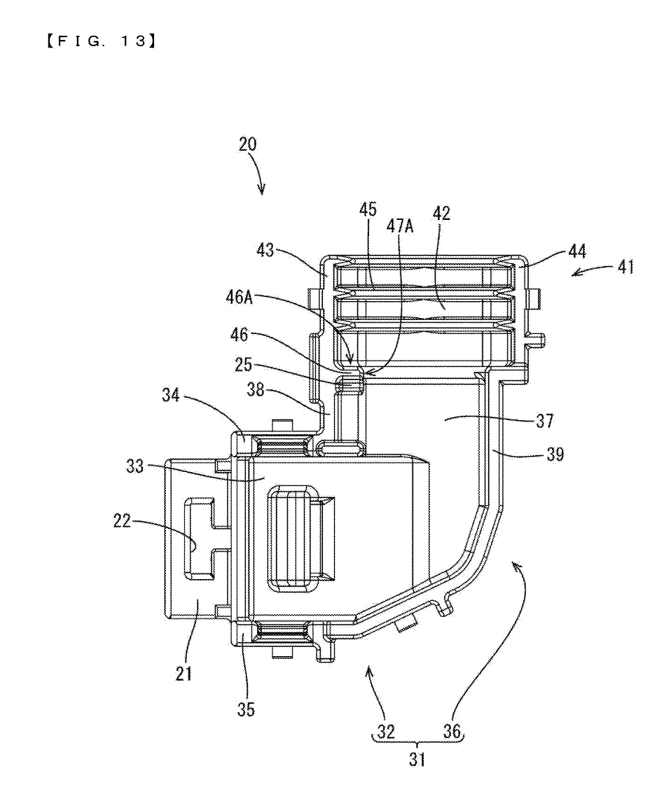

The first cover main body 31 is a part that has the shape of an L-like tube split in half, and, as shown in FIGS. 13 and 14, includes a first orthogonal half-tube part 32 that constitutes the orthogonal tube part 11, and a first parallel half-tube part 36 that constitutes the parallel tube part 12.

The first orthogonal half-tube part 32, as a whole, has the shape of a U-like groove, and, as shown in FIG. 13, includes a first orthogonal main wall 33, a first orthogonal inner wall 34 that extends from the first orthogonal main wall 33, and a first orthogonal outer wall 35 that also extends from the first orthogonal main wall 33. The first orthogonal inner wall 34 and the first orthogonal outer wall 35 extend in a direction that is orthogonal to the first orthogonal main wall 33, and are arranged so as to face each other.

The first parallel half-tube part 36, as a whole, has the shape of a U-like groove, and, as shown in FIG. 13, is continuous with the first orthogonal half-tube part 32 and extends in a direction that is orthogonal to the first orthogonal half-tube part 32. The first parallel half-tube part 36 includes a first parallel main wall 37 that is continuous with the first orthogonal main wall 33, a first parallel inner wall 38 that extends from the first parallel main wall 37, and a first parallel outer wall 39 that also extends from the first parallel main wall 37. The first parallel inner wall 38 and the first parallel outer wall 39 extend in a direction that is orthogonal to the first parallel main wall 37, and are arranged so as to face each other. The first parallel inner wall 38 is connected to the first orthogonal inner wall 34, and the first parallel outer wall 39 is connected to the first orthogonal outer wall 35.

The first orthogonal inner wall 34 and the first parallel inner wall 38 are walls that are arranged inside the L shape that is constituted by the first orthogonal half-tube part 32 and the first parallel half-tube part 36, and the first orthogonal outer wall 35 and the first parallel outer wall 39 are walls that are arranged outside the L shape.

The first holding half-tube part 41 is a part that has the shape of a U-like groove that is continuous with the first parallel half-tube part 36, and that extends to the side opposite to the orthogonal tube part 11, along a direction in which the first parallel half-tube part 36 extends. As shown in FIG. 13, the first holding half-tube part 41 includes a first holding main wall 42 that is continuous with the first parallel main wall 37, a first holding inner wall 43 that extends from the first holding main wall 42, and a first holding outer wall 44 that also extends from the first holding main wall 42. The first holding inner wall 43 and the first holding outer wall 44 extend in a direction that is orthogonal to the first holding main wall 42, and are arranged so as to face each other. The first holding main wall 42, the first holding inner wall 43, and the first holding outer wall 44 each constitute a part of a peripheral wall that surrounds the corrugated tube 90 in the holding tube part 13.

The first holding half-tube part 41 has a plurality of lines of holding protrusions 45. Each holding protrusion 45 is a linear part that protrudes from an inner wall surface of the first holding half-tube part 41 toward the inside of the first holding half-tube part 41, and extends along the circumferential direction of the holding tube part 13. The inner wall surface of the first holding half-tube part 41 is constituted by the respective inner wall surfaces of the first holding main wall 42, the first holding inner wall 43, and the first holding outer wall 44.

The first holding half-tube part 41 is slightly wider than the first parallel half-tube part 36, and a part of the first holding half-tube part 41 bulges more outward compared to the first parallel outer wall 39.

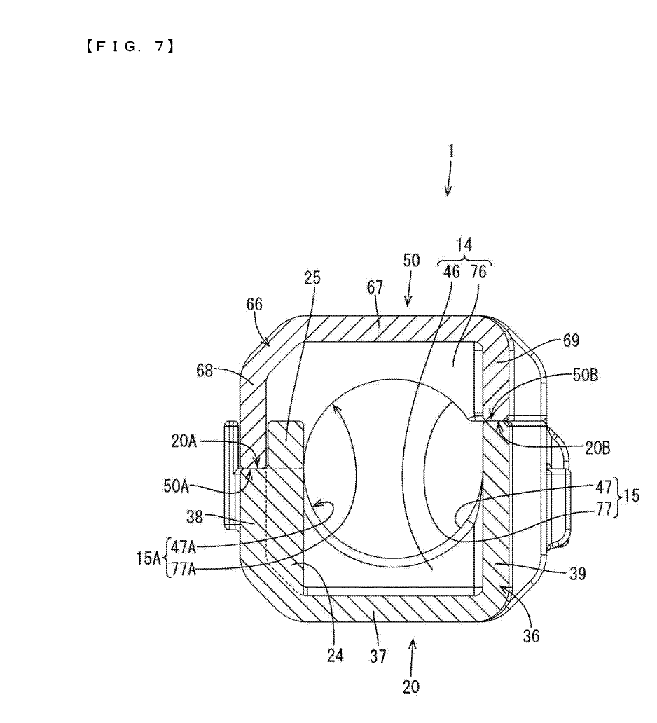

As shown in FIG. 13, the first holding half-tube part 41 has a first locking wall 46. The first locking wall 46 is a wall part that extends from a peripheral wall of the first holding half-tube part 41 toward the inside of the first holding half-tube part 41. The peripheral wall of the first holding half-tube part 41 is constituted by the first holding main wall 42, the first holding inner wall 43, and the first holding outer wall 44. A part of the first locking wall 46 that extends from the first holding outer wall 44 constitutes a wall part that connects the first parallel outer wall 39 and the first holding outer wall 44, and the remaining part of the first locking wall 46 protrudes to the inside of the first half cover 20. A surface of the first locking wall 46 that faces the first holding half-tube part 41 is a locking surface 46A that abuts against one end of the corrugated tube 90. The first locking wall 46 has a first recessed part 47 that is recessed relative to an end surface that faces the second half cover 50, and is defined by an inner circumferential edge 47A that has the shape of a semicircular arc (see FIG. 7 also).

As shown in FIGS. 13 and 14, the lock wall part 21 is a wall part that is continuous with the first orthogonal main wall 33, and that engages with a corresponding lock protrusion 82. The lock wall part 21 has a lock hole 22 that receives the lock protrusion 82.

The first half cover 20 has matching surfaces 20A and 20B that abut against the second half cover 50 when the first half cover 20 is attached to the second half cover 50. The respective protruding end surfaces of the first orthogonal inner wall 34, the first parallel inner wall 38, and the first holding inner wall 43 (the surfaces on the side opposite to the first orthogonal main wall 33, the first parallel main wall 37, and the first holding main wall 42) that face the second half cover 50 constitute a first inner matching surface 20A (corresponding to the first matching surface). The respective protruding end surfaces of the first orthogonal outer wall 35, the first parallel outer wall 39, and the first holding outer wall 44 (the surfaces on the side opposite to the first orthogonal main wall 33, the first parallel main wall 37, and the first holding main wall 42) that face the second half cover 50 constitute a first outer matching surface 20B.

As shown in FIGS. 7 and 13, the first half cover 20 has a bulging part 24 that bulges from the first locking wall 46, and an electrical wire restricting protrusion 25 that protrudes from the bulging part 24.

The bulging part 24 is a part that protrudes from a corner part that is constituted by the first locking wall 46 and the first parallel inner wall 38, toward the inside of the first parallel half-tube part 36.

The electrical wire restricting protrusion 25 is a protrusion that is continuous with the bulging part 24, and, as shown in FIG. 7, protrudes toward the second half cover 50 relative to the first inner matching surface 20A.

The first half cover 20 has a plurality of lock protrusions 23 for locking to the second half cover 50. Each lock protrusion 23 is a protrusion that protrudes outward from the first orthogonal outer wall 35, the first orthogonal inner wall 34, the first holding outer wall 44, and the first holding inner wall 43.

### Second Half Cover 50

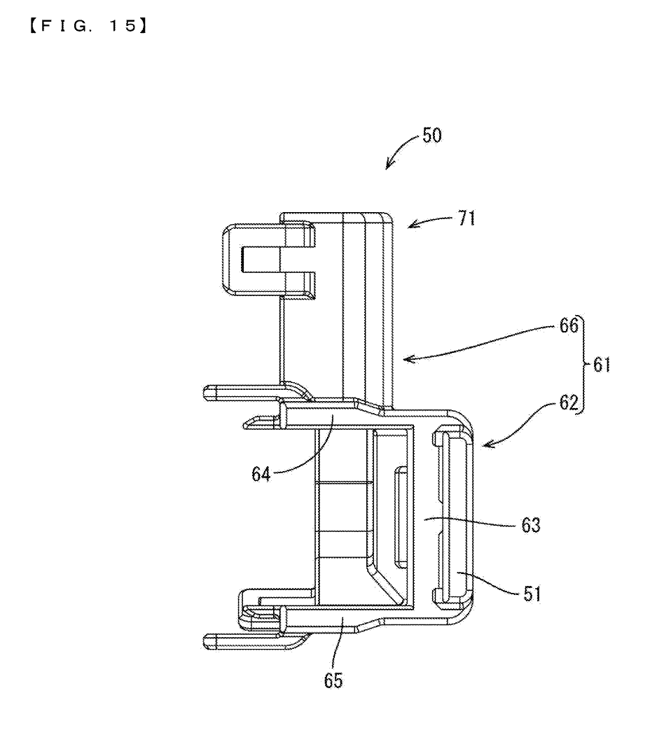

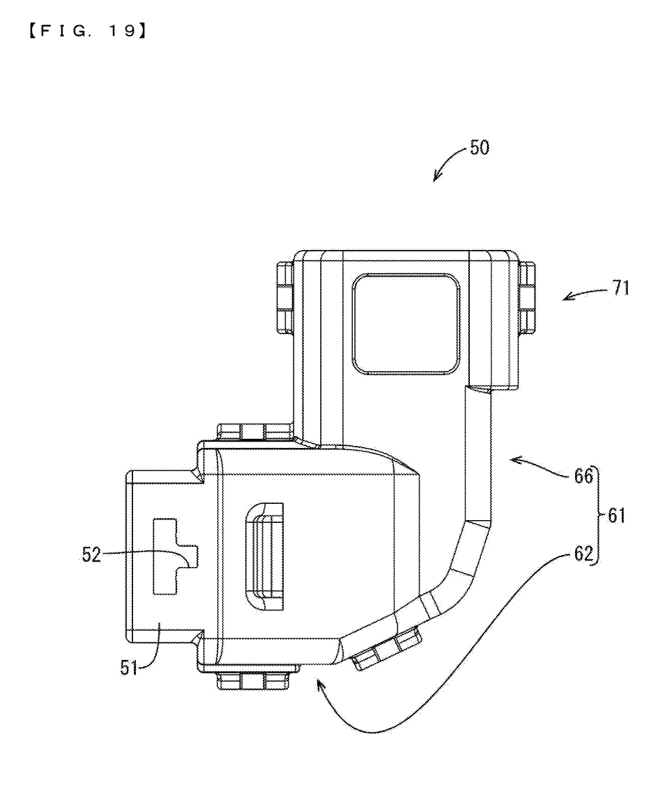

As shown in FIGS. 15 to 20, the second half cover 50, as a whole, has the shape of an L-like tube split in half, and, as shown in FIG. 19, includes a second cover main body 61, a second holding half-tube part 71, and a lock wall part 51.

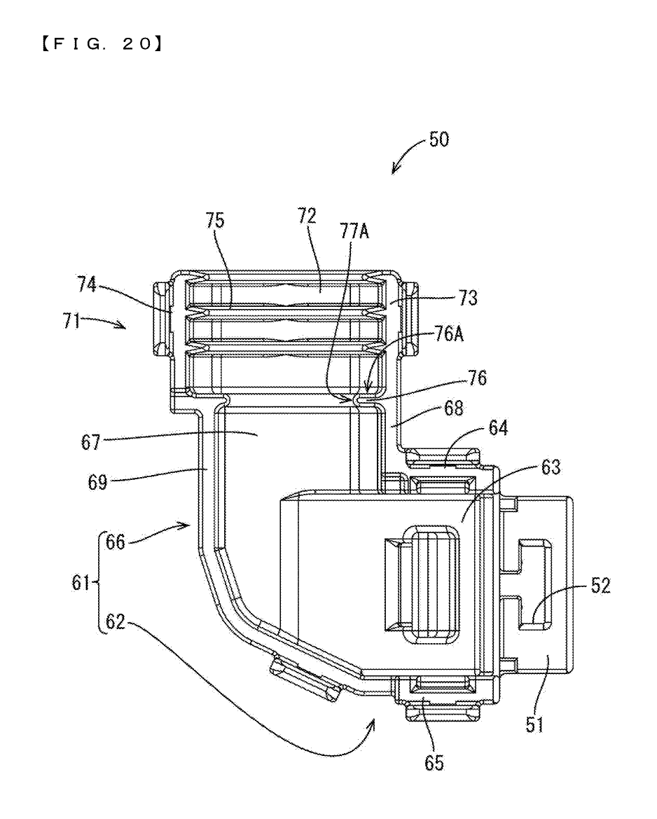

The second cover main body 61 is a part that has the shape of an L-like tube split in half, and, as shown in FIGS. 19 and 20, includes a second orthogonal half-tube part 62 that constitutes the orthogonal tube part 11, and a second parallel half-tube part 66 that constitutes the parallel tube part 12.

The second orthogonal half-tube part 62, as a whole, has the shape of a U-like groove, and, as shown in FIG. 20, includes a second orthogonal main wall 63, a second orthogonal inner wall 64 that extends from the second orthogonal main wall 63, and a second orthogonal outer wall 65 that also extends from the second orthogonal main wall 63. The second orthogonal inner wall 64 and the second orthogonal outer wall 65 extend in a direction that is orthogonal to the second orthogonal main wall 63, and are arranged so as to face each other.

The second parallel half-tube part 66, as a whole, has the shape of a U-like groove, and, as shown in FIG. 20, is continuous with the second orthogonal half-tube part 62 and extends in a direction that is orthogonal to the second orthogonal half-tube part 62. The second parallel half-tube part 66 includes a second parallel main wall 67 that is continuous with the second orthogonal main wall 63, a second parallel inner wall 68 that extends from the second parallel main wall 67, and a second parallel outer wall 69 that also extends from the second parallel main wall 67. The second parallel inner wall 68 and the second parallel outer wall 69 extend in a direction that is orthogonal to the second parallel main wall 67, and are arranged so as to face each other. The second parallel inner wall 68 is connected to the second orthogonal inner wall 64, and the second parallel outer wall 69 is connected to the second orthogonal outer wall 65.

The second orthogonal inner wall 64 and the second parallel inner wall 68 are walls that are arranged inside the L shape that is constituted by the second orthogonal half-tube part 62 and the second parallel half-tube part 66, and the second orthogonal outer wall 65 and the second parallel outer wall 69 are walls that are arranged outside the L shape that is constituted by the second orthogonal half-tube part 62 and the second parallel half-tube part 66.

The second holding half-tube part 71 is a part that has the shape of a U-like groove that is continuous with the second parallel half-tube part 66, and that extends to the side opposite to the orthogonal tube part 11, along a direction in which the second parallel half-tube part 66 extends. As shown in FIG. 20, the second holding half-tube part 71 includes a second holding main wall 72 that is continuous with the second parallel main wall 67, a second holding inner wall 73 that extends from the second holding main wall 72, and a second holding outer wall 74 that also extends from the second holding main wall 72. The second holding inner wall 73 and the second holding outer wall 74 extend in a direction that is orthogonal to the second holding main wall 72, and are arranged so as to face each other. The second holding main wall 72, the second holding inner wall 73, and the second holding outer wall 74 each constitute a part of a peripheral wall that surrounds the corrugated tube 90 in the holding tube part 13.

The second holding half-tube part 71 has a plurality of lines of holding protrusions 75. Each holding protrusion 75 is a linear part that protrudes from an inner wall surface of the second holding half-tube part 71 toward the inside of the second holding half-tube part 71. The inner wall surface of the second holding half-tube part 71 is constituted by the respective inner wall surfaces of the second holding main wall 72, the second holding inner wall 73, and the second holding outer wall 74.

The second holding half-tube part 71 is slightly wider than the second parallel half-tube part 66, and a part of the second holding half-tube part 71 bulges more outward compared to the second parallel outer wall 69.

As shown in FIG. 20, the second holding half-tube part 71 has a second locking wall 76. The second locking wall 76 is a wall part that extends from a peripheral wall of the second holding half-tube part 71 toward the inside of the second holding half-tube part 71. The peripheral wall of the second holding half-tube part 71 is constituted by the second holding main wall 72, the second holding inner wall 73, and the second holding outer wall 74. A part of the second locking wall 76 that extends from the second holding outer wall 74 constitutes a wall part that connects the second parallel outer wall 69 and the second holding outer wall 64, and the remaining part of the second locking wall 76 protrudes to the inside of the second half cover 50. A surface of the second locking wall 76 that faces the second holding half-tube part 71 is a locking surface 76A that abuts against one end of the corrugated tube 90. The second locking wall 76 has a second recessed part 77 that is recessed relative to an end surface that faces the first half cover 20, and is defined by an inner circumferential edge 77A that has the shape of a semicircular arc (see FIG. 7 also).

As shown in FIGS. 19 and 20, the lock wall part 51 is a wall part that is continuous with the second orthogonal main wall 63, and that engages with a corresponding lock protrusion 82. The lock wall part 51 has a lock hole 52 that receives the lock protrusion 82.

The second half cover 50 has matching surfaces 50A and 50B that abut against the first half cover 20 when the second half cover 50 is attached to the first half cover 20. The respective protruding end surfaces of the second orthogonal inner wall 64, the second parallel inner wall 68, the second holding inner wall 73, and the second locking wall 76 (the surfaces on the side opposite to the second orthogonal main wall 63, the second parallel main wall 67, and the second holding main wall 72) that face the first half cover 20 constitute a second inner matching surface 50A (corresponding to the second matching surface). The respective protruding end surfaces of the second orthogonal outer wall 65, the second parallel outer wall 69, and the second holding outer wall 74 (the surfaces on the side opposite to the second orthogonal main wall 63, the second parallel main wall 67, and the second holding main wall 72) that face the first half cover 20 constitute a second outer matching surface 50B.

The second half cover 50 has a plurality of lock pieces 53 for locking to the lock protrusions 23 of the first half cover 20. Each lock piece 53 is a U-shaped plate piece that extends from the first orthogonal outer wall 35, the first orthogonal inner wall 34, the first holding outer wall 44, and the first holding inner wall 43, and engages with a corresponding lock protrusion 23 by allowing the lock protrusion 23 to enter the inside of the U shape.

### Assembly of Electrical Wire Cover 1

The following describes a method for assembling the electrical wire cover 1, the corrugated tube 90, and the connector housing 80 to each other.

First, the electrical wires W connected to the metal terminal parts are inserted into the corrugated tube 90, and the metal terminal parts are housed in the connector housing 80.

Next, the first half cover 20 is attached to the corrugated tube 90 and the connector housing 80. The corresponding lock protrusion 82 is fitted into the lock hole 22 of the lock wall part 21, and thus the first half cover 20 is locked to the connector housing 80. Also, the holding protrusions 75 are positioned so as to be fitted into the holding grooves 91, and one end part of the corrugated tube 90 is held by the first half cover 20. At this time, the plurality of electrical wires W lead out from the connector housing 80 are bundled together and bent, and are routed inside the first half cover 20.

In the part where the first locking wall 46 is located, the electrical wires W are routed inside the first recessed part 47.

Next, the second half cover 50 is attached to the first half cover 20. The corresponding lock protrusion 82 is fitted into the lock hole 52 of the lock wall part 51, and thus the second half cover 50 is locked to the connector housing 80. Also, the holding protrusions 75 are positioned so as to be fitted into the holding grooves 91, and the one end part of the corrugated tube 90 is sandwiched between the second half cover 50 and the first half cover 20. The first half cover 20 and the second half cover 50 are locked to each other in a combined state due to the lock pieces 53 engaging with the lock protrusions 23.

As shown in FIGS. 1, 2, and 3, in the state of having been assembled, the first half cover 20 and the second half cover 50 are combined so as to face each other and constitute a tube shape, and the electrical wires W are inserted thereinto. The first half cover 20 and the second half cover 50 are combined such that the first inner matching surface 20A and the second inner matching surface 50A abut against each other and the first outer matching surface 20B and the second outer matching surface 50B abut against each other.

As shown in FIG. 7, the position at which the first inner matching surface 20A and the second inner matching surface 50A abut against each other is located at a center point position between the first half cover 20 and the second half cover 50 (i.e. a midpoint position between the first parallel main wall 37 and the second parallel main wall 67). The first outer matching surface 20B and the second outer matching surface 50B are partially uneven. As shown in FIG. 7, regarding a portion of the orthogonal tube part 11 that is close to the parallel tube part 12, the parallel tube part 12, and a portion of the holding tube part 13 that is close to the parallel tube part 12, the position at which the first outer matching surface 20B and the second outer matching surface 50B abut against each other is located closer to the second half cover 50 than the center point position between the first half cover 20 and the second half cover 50 is (i.e. located closer to the second parallel main wall 67 than the midpoint position between the first parallel main wall 37 and the second parallel main wall 67). Regarding the remaining portion, the position at which the first outer matching surface 20B and the second outer matching surface 50B abut against each other is located at the center point position between the first half cover 20 and the second half cover 50 (i.e. the midpoint position between the first parallel main wall 37 and the second parallel main wall 67).

The corrugated tube 90 is held inside the holding tube part 13. The first locking wall 46 and the second locking wall 76 are combined, and constitute a locking wall 14 that has an electrical wire insertion hole 15, as shown in FIG. 7. The electrical wire insertion hole 15 is a hole constituted by the first recessed part 47 and the second recessed part 77, and has a hole edge 15A that is constituted by the inner circumferential edges 47A and 77A and is circular. The electrical wires W are inserted into the electrical wire insertion hole 15. The inner diameter of the electrical wire insertion hole 15 is smaller than the outer diameter of the corrugated tube 90. One end of the corrugated tube 90 abuts against the locking surfaces 46A and 76A, and thus the corrugated tube 90 is restricted from entering the inside of the cover main body 10.

As shown in FIG. 7, the electrical wire restricting protrusion 25 is located inside the second half cover 50, and is housed in the second parallel half-tube part 66 so as to be adjacent to the second locking wall 76.

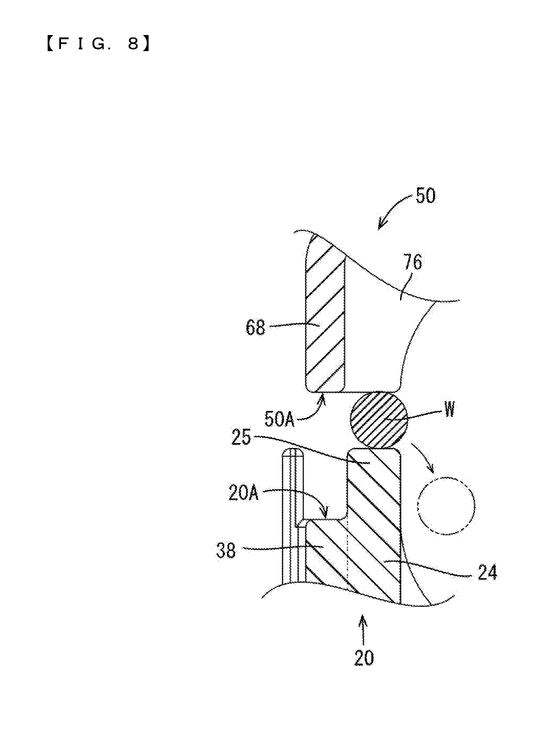

Here, when the electrical wire cover 1 is assembled, there is a concern that the electrical wires W may get caught between the first half cover 20 and the second half cover 50. However, according to the present embodiment, the first half cover 20 has the electrical wire restricting protrusion 25. Therefore, even if an electrical wire W routed inside the first half cover 20 juts out from the first half cover 20 and enters the gap between the first inner matching surface 20A and the second inner matching surface 50A, the electrical wire restricting protrusion 25 interferes with the electrical wire W, and the electrical wire W is pushed back to the inside of the first half cover 20 or pushed out of the first half cover 20 (see FIG. 8). If the electrical wire W is pushed back to the inside, the electrical wire W returns to a proper routing position, and the electrical wire W is prevented from getting caught. Also, if the electrical wire W is pushed to the outside, an operator can be aware that the electrical wire W is jutting out. Therefore, the operator can promptly take an appropriate measure such as routing the electrical wire W again.

In particular, in the part where the locking wall 14 is located, the width of the routing pathway of the electrical wires W is narrower than in other parts and the electrical wires W are likely to jut out from the pathway. In the present embodiment, the electrical wire restricting protrusion 25 protrudes from the bulging part 24 that protrudes from the corner part that is constituted by the first locking wall 46 and the first parallel inner wall 38. In other words, the electrical wire restricting protrusion 25 is located adjacent to the locking wall 14. In this way, the electrical wire restricting protrusion 25 is located adjacent to the part in which the electrical wires W are likely to juts out from the pathway, and therefore it is possible to effectively prevent the electrical wires W from getting caught.

Also, as shown in FIG. 7, the electrical wire restricting protrusion 25 is located outside the hole edge 15A of the electrical wire insertion hole 15 (i.e. at a position that is close to the second parallel inner wall 68). Due to this configuration, the electrical wire restricting protrusion 25 is located outside the pathway along which the electrical wires W are routed, and therefore it is possible to prevent the routing of the electrical wires W from being hindered by the electrical wire restricting protrusion 25.

As described above, according to the present embodiment, the electrical wire cover 1 is a member that has a tube shape when the first half cover 20 that has a half tube shape and the second half cover 50 that has a half tube shape and is to be attached to the first half cover 20 are assembled, and houses the electrical wires W. The first half cover 20 has the first inner matching surface 20A, and the second half cover 50 has the second inner matching surface 50A that abuts against the first inner matching surface 20A when the second half cover 50 is attached to the first half cover 20. The first half cover 20 has the electrical wire restricting protrusion 25. This electrical wire restricting protrusion 25 is a protrusion that protrudes toward the second half cover 50 relative to the first inner matching surface 20A.

With the above-described configuration, when the first half cover 20 and the second half cover 50 are assembled, even if an electrical wire W routed inside juts out to the outside and enter the gap between the first inner matching surface 20A and the second inner matching surface 50A, the electrical wire restricting protrusion 25 interferes with the electrical wire W, and the electrical wire W is pushed back to the inside or pushed to the outside. If the electrical wire W is pushed back to the inside, the electrical wire W returns to a proper routing position, and the electrical wire W is prevented from getting caught. Also, if the electrical wire W is pushed to the outside, an operator can be aware that the electrical wire W is jutting out, by visually checking the electrical wire W from the outside of the electrical wire cover 1. Therefore, the operator can promptly take an appropriate measure such as routing the electrical wire W again and assembling the electrical wire cover 1 again. As a result, it is possible to prevent the electrical wire W from getting caught between the first half cover 20 and the second half cover 50, and it is possible to avoid a reduction in the ease of assembly.

Also, the electrical wire cover 1 has the cover main body 10 and the holding tube part 13 that is continuous with the cover main body 10. The holding tube part 13 is a part that holds the corrugated tube 90 that is to be attached to the electrical wires W, and includes: the peripheral walls (the first holding main wall 42, the first holding inner wall 43, the first holding outer wall 44, the second holding main wall 72, the second holding inner wall 73, and the second holding outer wall 74) that surround the electrical wires W and the corrugated tube 90; and the locking wall 14 (the first locking wall 46 and the second locking wall 76) that extends inward from the peripheral walls and has the electrical wire insertion hole 15. The electrical wire restricting protrusion 25 is located adjacent to the locking wall 14.

Here, in the part where the locking wall 14 is located, the width of the routing pathway of the electrical wires W is narrower than in other parts, and the electrical wires W are likely to jut out from the pathway. The electrical wire restricting protrusion 25 is located adjacent to such a part, and therefore it is possible to effectively prevent the electrical wires W from getting caught.

Furthermore, the electrical wire restricting protrusion 25 is located outside the hole edge 15A of the electrical wire insertion hole 15. Due to this configuration, the electrical wire restricting protrusion 25 is located outside the pathway along which the electrical wires W are routed, and therefore it is possible to prevent the routing of the electrical wires W from being hindered by the electrical wire restricting protrusion 25.

The technology disclosed by the present specification is not intended to be limited to the embodiment described using the above descriptions and the drawings, and also encompasses various aspects such as the following.

Although the first half cover 20 and the second half cover 50 are separate bodies in the above-described embodiment, the first half cover and the second half cover may be connected to each other by using a hinge.

Although the electrical wire cover 1 has the shape of an L-like tube in the above-described embodiment, the electrical wire cover may have the shape of a straight tube.

Although the electrical wire restricting protrusion 25 is located adjacent to the locking wall 14 in the above-described embodiment, the electrical wire restricting protrusion may be located away from the locking wall.

Although the first half cover 20 has one electrical wire restricting protrusion in the above-described embodiment, the second half cover may have one electrical wire restricting protrusion, and the first half cover and the second half cover may each have one or more electrical wire restricting protrusions.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SIGNS LIST

1: Electrical wire cover

10: Cover main body

13: Holding tube part (Holding part)

14: Locking wall

15: Electrical wire insertion hole

15A: Hole edge

20: First half cover

20A: First inner matching surface (First matching surface)

24: Electrical wire restricting protrusion

42: First holding main wall (Peripheral wall)

43: First holding inner wall (Peripheral wall)

44: First holding outer wall (Peripheral wall)

50: Second half cover

50A: Second inner matching surface (Second matching surface)

90: Corrugated tube (Protection member)

72: Second holding main wall (Peripheral wall)

73: Second holding inner wall (Peripheral wall)

74: Second holding outer wall (Peripheral wall)

W: Electrical wire

1. An electrical wire cover having a tube shape when a first half cover that has a half tube shape and a second half cover that has a half tube shape are assembled, and configured to house an electrical wire,
wherein the first half cover has a first matching surface, and the second half cover has a second matching surface that abuts against the first matching surface when the second half cover is attached to the first half cover,
one half cover out of the first half cover and the second half cover has an electrical wire restricting protrusion, and
the electrical wire restricting protrusion is a protrusion that protrudes toward the other half cover out of the first half cover and the second half cover, relative to one matching surface, out of the first matching surface and the second matching surface, of the one half cover.

2. The electrical wire cover according to claim 1,
further comprising: a cover main body; and a holding part that is continuous with the cover main body and holds a protection member that is to be attached to the electrical wire,
the holding part includes: a peripheral wall that is configured to surround the electrical wire and the protection member; and a locking wall that extends inward from the peripheral wall, has an electrical wire insertion hole into which the electrical wire is to be inserted, and is locked to the protection member, and
the electrical wire restricting protrusion is located adjacent to the locking wall.

3. The electrical wire cover according to claim 2,
wherein the electrical wire restricting protrusion is located outside a hole edge of the electrical wire insertion hole.
